(19) United States
(12) Patent Application Publication
(10) Pub. No.: US 2011/0026837 A1
(43) Pub. Date: Feb. 3, 2011

(54) IMAGE PROCESSING DEVICE AND METHOD

(75) Inventor: Kazunori KITA, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Casio Computer Co., Ltd., Tokyo (JP)

(21) Appl. No.: 12/845,944

(22) Filed: Jul. 29, 2010

(30) Foreign Application Priority Data
Jul. 31, 2009 (JP) 2009-179549

(51) Int. Cl. G06K 9/62

(52) U.S. Cl. 382/209

(57) ABSTRACT

It is an object of the present invention to provide an image processing device capable of capturing an image of various objects and common scenes with ideal compositions and attractive compositions. The image processing device predicts an attention region 52 for a through image 51, based on a saliency map S having a plurality of feature quantity maps Fc, Fh, and Fs integrated therein (steps Sa to Sc). The image processing device extracts line components (e.g., edge SL) of an edge image 53 (step Se, Sf) corresponding to the through image 51. The image processing device uses the attention region 52, the line components (e.g., edge component SL), or the like and identifies, from among a plurality of model composition suggestions, a model composition suggestion that resembles the through image 51 in regard to a state of positioning of the principal object.

This application is based on and claims the benefit of priority from Japanese Patent Application No. 2009-179549, filed on 31 Jul. 2009, the content of which is incorporated herein by reference.

### BACKGROUND OF THE INVENTION

1. Field of the Invention

The present invention relates to an image processing device and method, and particularly relates to a technology that enables imaging with ideal compositions and attractive compositions of various objects and common scenes.

2. Related Art

Heretofore, when users perform imaging with cameras, captured images that are different from what is intended may be obtained. In order to avoid such mistakes, various measures have been proposed.

For example, there are occasions in which, when imaging all of the scenery surrounding a person or the like is attempted, the person or the like is made small in the image. A measure to avoid this phenomenon is proposed in Japanese Patent Application No. 2006-148344 and the like.

As another example, by using a lens with a small f-value (a large aperture) or opening up an aperture to lower the f-value, a user may focus only on the foreground and produce an image in which the background is blurred. However, there are occasions in which imaging is performed with conditions in which the degree of blurring is inappropriate. A measure to avoid this phenomenon is proposed in Japanese Patent Application No. H06-30349 and the like.

As a further example, in cases such as when a user is distracted in focusing or the like, imaging is performed with a composition in which an object is disposed in the middle. In these cases, there are occasions in which the captured image is the sort of image captured by a beginner, or is a monotonous descriptive image. Measures to avoid this phenomenon are proposed in Japanese Patent Application Nos. 2002-232753, 2007-174548, and the like.

### SUMMARY OF THE INVENTION

However, there may be occasions in which ideal compositions and attractive compositions may not be captured with various objects and common scenes. Even if measures from the related art, including Japanese Patent Application Nos. 2006-148344, H06-30349, 2002-232753, and 2007-174548, are applied in order to avoid this phenomenon, it is difficult to effectively avoid it.

Accordingly, it is an object of the present invention to enable imaging of various objects and common scenes with ideal compositions and attractive compositions.

According to a first aspect of the present invention, an image processing device is provided that is provided with: a prediction section that predicts an attention region for an input image including a principal object, based on a plurality of feature quantities extracted from the input image; and an identification section that identifies, using the attention region thus predicted by the prediction section, a model composition suggestion that resembles the input image in regard to a state of positioning of the principal object, from among a plurality of model composition suggestions.

According to a second aspect of the present invention, an image processing method is provided that includes: a prediction step of predicting an attention region for an input image including a principal object, based on a plurality of feature quantities extracted from the input image; and an identification step of identifying, using the attention region predicted by the processing of the prediction step, a model composition suggestion that resembles the input image in regard to positioning of the principal object, from among a plurality of model composition suggestions.

According to the present invention, it is possible to perform imaging of various objects and common scenes with ideal compositions and attractive compositions.

### BRIEF DESCRIPTION OF THE DRAWINGS

FIG. 1 is a block diagram of hardware of an image processing device relating to a first embodiment of the present invention;

FIG. 2 is a diagram illustrating an outline of scene composition identification processing relating to the first embodiment of the present invention;

FIG. 3 is a diagram illustrating an example of table information in which various kinds of information are stored for each model composition suggestion, which is used in the composition categorization processing of the scene composition identification processing relating to the first embodiment of the present invention;

FIG. 4 is a diagram illustrating an example of table information in which various kinds of information are stored for each model composition suggestion, which is used in the composition categorization processing of the scene composition identification processing relating to a first embodiment of the present invention;

FIG. 5 is a flowchart illustrating an example of a flow of the imaging mode processing relating to the first embodiment of the present invention;

FIG. 6 is a diagram illustrating specific processing results of the imaging mode processing relating to the first embodiment of the present invention;

FIG. 7 is a flowchart illustrating a detailed example of flow of the scene composition identification processing of the imaging mode processing relating to the first embodiment of the present invention;

FIG. 8 is a flowchart illustrating a detailed example of a flow of an attention region prediction processing of the imaging mode processing relating to the first embodiment of the present invention;

FIG. 9 is a set of flowcharts illustrating an example of flows of feature quantity map creation processing of the imaging mode processing relating to the first embodiment of the present invention;

FIG. 10 is a set of flowcharts illustrating an example of flows of feature quantity map creation processing of the imaging mode processing relating to the first embodiment of the present invention;

FIGS. 11A and 11B are a set of flowcharts illustrating a detailed example of flow of composition analysis processing of the imaging mode processing relating to the first embodiment of the present invention; and

FIG. 12 illustrates a display example of a liquid crystal display 13, relating to a second embodiment of the present invention.

### DETAILED DESCRIPTION OF THE INVENTION

### First Embodiment

Hereinafter, a first embodiment of the present invention is described on the basis of the appended drawings.

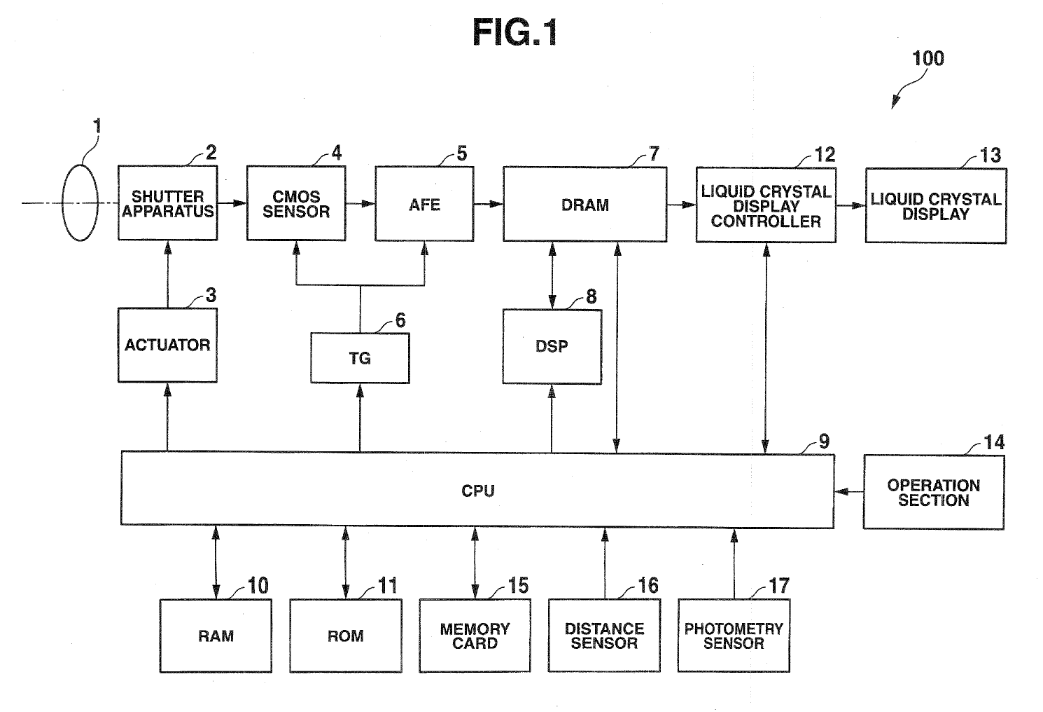

FIG. 1 is a block diagram of hardware of an image processing device 100 relating to the first embodiment of the present invention. The image processing device 100 may be constituted by, for example, a digital camera.

The image processing device 100 is provided with an optical lens apparatus 1, a shutter apparatus 2, an actuator 3, a complementary metal oxide semiconductor (CMOS) sensor 4, an analog front end (AFE) 5, a timing generator (TG) 6, dynamic random access memory (DRAM) 7, a digital signal processor (DSP) 8, a central processing unit (CPU) 9, random access memory (RAM) 10, read-only memory (ROM) 11, a liquid crystal display controller 12, a liquid crystal display 13, an operation section 14, a memory card 15, a distance sensor 16 and a photometry sensor 17.

The optical lens apparatus 1 is structured with, for example, a focusing lens, a zoom lens and the like. The focusing lens is a lens for focusing an object image at a light detection surface of the CMOS sensor 4.

The shutter apparatus 2 is structured by, for example, shutter blades and the like. The shutter apparatus 2 functions as a mechanical shutter that blocks light flux incident on the CMOS sensor 4. The shutter apparatus 2 also functions as an aperture that regulates light amounts of light flux incident on the CMOS sensor 4. The actuator 3 opens and closes the shutter blades of the shutter apparatus 2 in accordance with control by the CPU 9.

The CMOS sensor 4 is structured of, for example, a CMOS-type image sensor or the like. A subject image from the optical lens apparatus 1 is incident on the CMOS sensor 4 via the shutter apparatus 2. In accordance with clock pulses provided from the TG 6, the CMOS sensor 4 optoelectronically converts (images) the subject image at intervals of a certain duration and accumulates image signals, and sequentially outputs the accumulated image signals as analog signals.

The analog image signals from the CMOS sensor 4 are provided to the AFE 5. In accordance with clock pulses provided from the TG 6, the AFE 5 applies various kinds of signal processing to the analog image signals, such as analog-to-digital (A/D) conversion processing and the like. Consequent to the various kinds of signal processing, digital signals are generated and are outputted from the AFE 5.

In accordance with control by the CPU 9, the TG 6 provides clock pulses at intervals of a certain duration to the CMOS sensor 4 and the AFE 5 respectively.

The DRAM 7 temporarily stores digital signals generated by the AFE 5, image data generated by the DSP 8 and the like.

In accordance with control by the CPU 9, the DSP 8 applies various kinds of image processing to the digital signals stored in the DRAM 7, such as white balance correction processing, gamma correction processing, YC conversion processing and so forth. Consequent to the various kinds of image processing, image data is generated, which is constituted of luminance signals and color difference process signals. Hereinafter, this image data is referred to as “frame image data”, and images represented by this frame image data are referred to as “frame image(s)”.

The CPU 9 controls overall operations of the image processing device 100. The RAM 10 functions as a working area when the CPU 9 is executing respective processing. The ROM 11 stores programs and data required for the image processing device 100 to execute respective processing, and the like. The CPU 9 executes various processing in cooperation with the programs stored in the ROM 11, with the RAM 10 serving as a working area.

In accordance with control by the CPU 9, the liquid crystal display controller 12 converts frame image data stored in the DRAM 7, or the memory card 15 or the like, to analog signals and provides the analog signals to the liquid crystal display 13. The liquid crystal display 13 displays frame images, which are images corresponding to analog signals provided from the liquid crystal display controller 12.

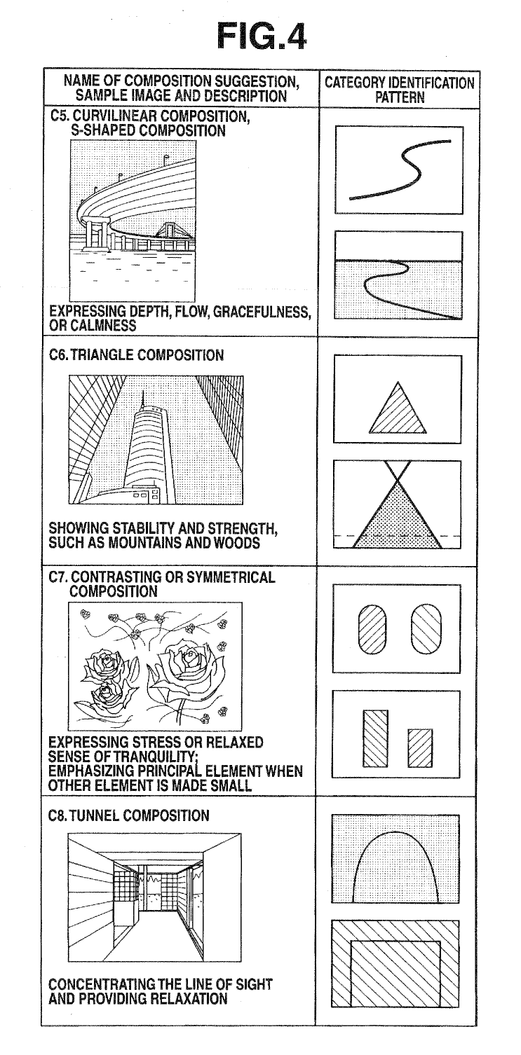

The liquid crystal display controller 12 also, in accordance with control by the CPU 9, converts various kinds of image data stored beforehand in the ROM 11 or such to analog signals, and provides the analog signals to the liquid crystal display 13. The liquid crystal display 13 displays images corresponding to the analog signals provided from the liquid crystal display controller 12. For example, in the present embodiment, image data of information sets capable of specifying different kinds of scenes (hereinafter referred to as “scene information”) is stored in the ROM 11. Herein, the “scene” indicates a static image such as a landscape scene, scenary scene, portrait, etc. Consequently, as described later with reference to FIG. 4, various kinds of scene information are suitably displayed at the liquid crystal display 13.

The operation section 14 accepts operations of various buttons by a user. The operation section 14 is provided with a power button, a cross-key button, a set button, a menu button, a shutter release button and the like.

The operation section 14 provides signals corresponding to the accepted operations of the various buttons by the user to the CPU 9. The CPU 9 analyses details of user operations on the basis of signals from the operation section 14, and executes processing in accordance with the details of the operations.

The memory card 15 records frame image data generated by the DSP 8. The distance sensor 16 senses a distance to an object in accordance with control by the CPU 9. The photometry sensor 17 senses luminance (brightness) of an object in accordance with control by the CPU 9.

Operational modes of the image processing device 100 with this structure include various modes, including an imaging mode and a playback mode. Hereinafter, for simplicity of description, only processing while in the imaging mode (hereinafter referred to as “imaging mode processing”) is described. Hereinafter, the imaging mode processing is mainly conducted by the CPU 9.

Next, a sequence of processing in the imaging mode processing of the image processing device 100 of FIG. 1, up to identification of the composition of a scene using an attention region based on a saliency map, is described in outline. Hereinafter, this processing is referred to as “scene composition identification processing”.

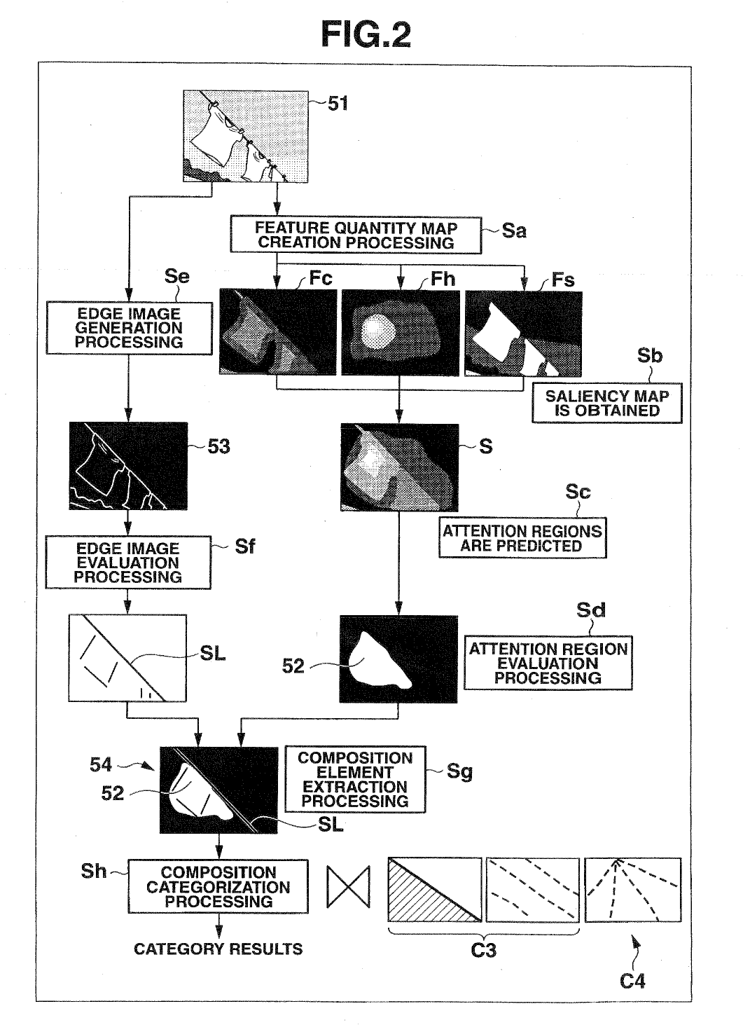

FIG. 2 is a diagram describing an outline of the scene composition identification processing.

When the imaging mode is started, the CPU 9 of the image processing device 100 of FIG. 1 causes imaging by the CMOS sensor 4 to be continuously performed, and causes frame image data successively generated by the DSP 8 to be temporarily stored in the DRAM 7. Hereinafter, this sequence of processing of the CPU 9 is referred to as “through-imaging”.

The CPU 9 controls the liquid crystal display controller 12 and the like, successively reads the frame image data recorded in the DRAM 7, and causes respective corresponding frame images to be displayed on the liquid crystal display 13. Hereinafter, this sequence of processing of the CPU 9 is referred to as “through-display”. The through-displayed frame images are referred to as “through-image(s)”.

In the following description, for example, a through-image 51 illustrated in FIG. 2 is displayed on the liquid crystal display 13 by the through-imaging and through-display.

In this case, in step Sa, the CPU 9 executes, for example, processing as follows to serve as feature quantity map creation processing.

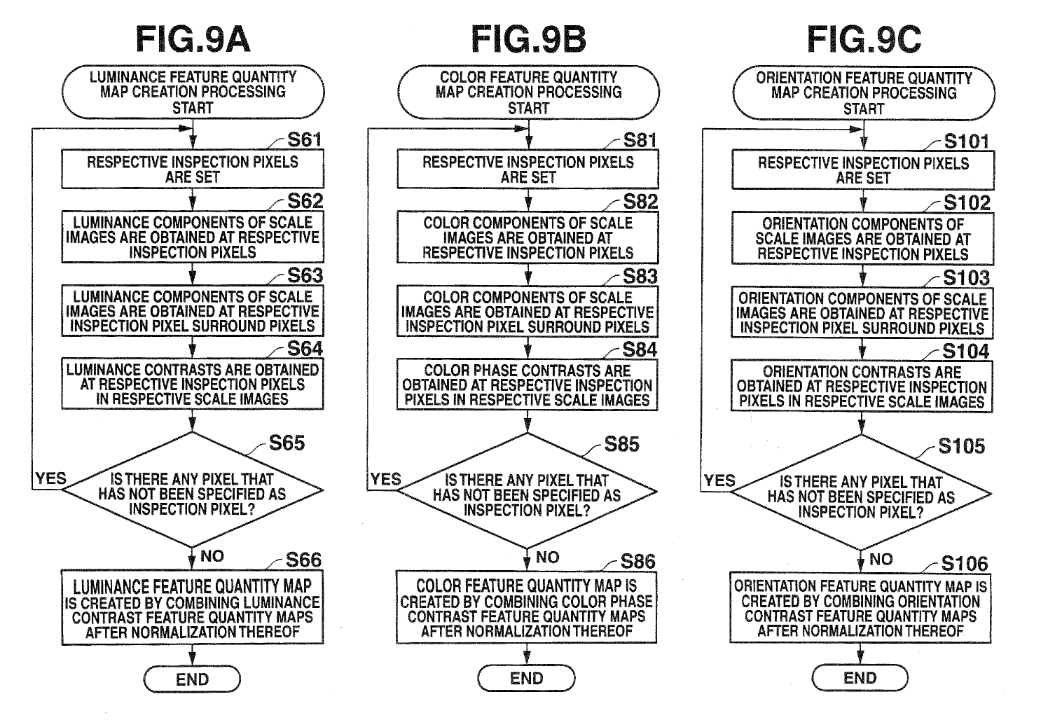

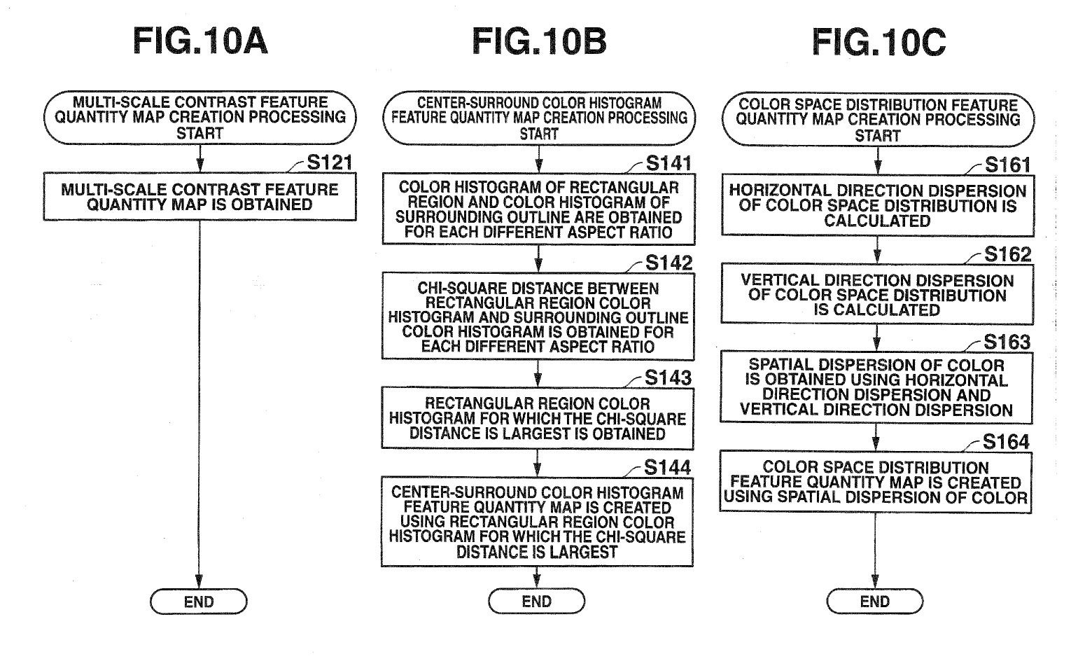

That is, the CPU 9 may create a plurality of categories of feature quantity maps for frame image data corresponding to the through-image 51, from contrasts of a plurality of categories of feature quantities such as color, orientation, luminance and the like. This sequence of processing, up to creating a feature quantity map of one predetermined category among the plurality of categories, is herein referred to as “feature quantity map creation processing”. Detailed examples of the feature quantity map creation processing of each category are described later with reference to FIG. 9A to FIG. 9C and FIG. 10A to FIG. 10C.

For example, in the example of FIG. 2, a feature quantity map Fc is created as a result of multi-scale contrast feature quantity map creation processing of FIG. 10A, which is described later. In addition, a feature quantity map Fh is created as a result of center-surround color histogram feature quantity map creation processing of FIG. 10B, which is described later. Furthermore, a feature quantity map Fs is created as result of a color space distribution feature quantity map creation processing of FIG. 10C, which is described later.

In step Sb, the CPU 9 obtains a saliency map by integrating the feature quantity maps of the plurality of categories. For example, in the example of FIG. 2, the feature quantity maps Fc, Fh and Fs are integrated to obtain a saliency map S.

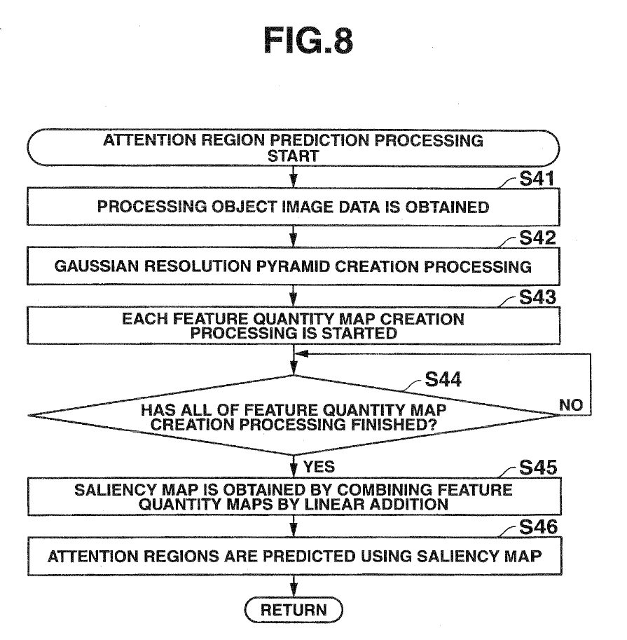

The processing of step Sb corresponds to the processing of step S45 in FIG. 8, which is described later.

In step Sc, the CPU 9 uses the saliency map to predict image regions in the through-image that have high probabilities of drawing the visual attention of a person (hereinafter referred to as “attention region(s)”). For example, in the example of FIG. 2, the saliency map S is used and an attention region 52 in the through-image 51 is predicted.

The processing of step Sc corresponds to the processing of step S46 in FIG. 8, which is described later.

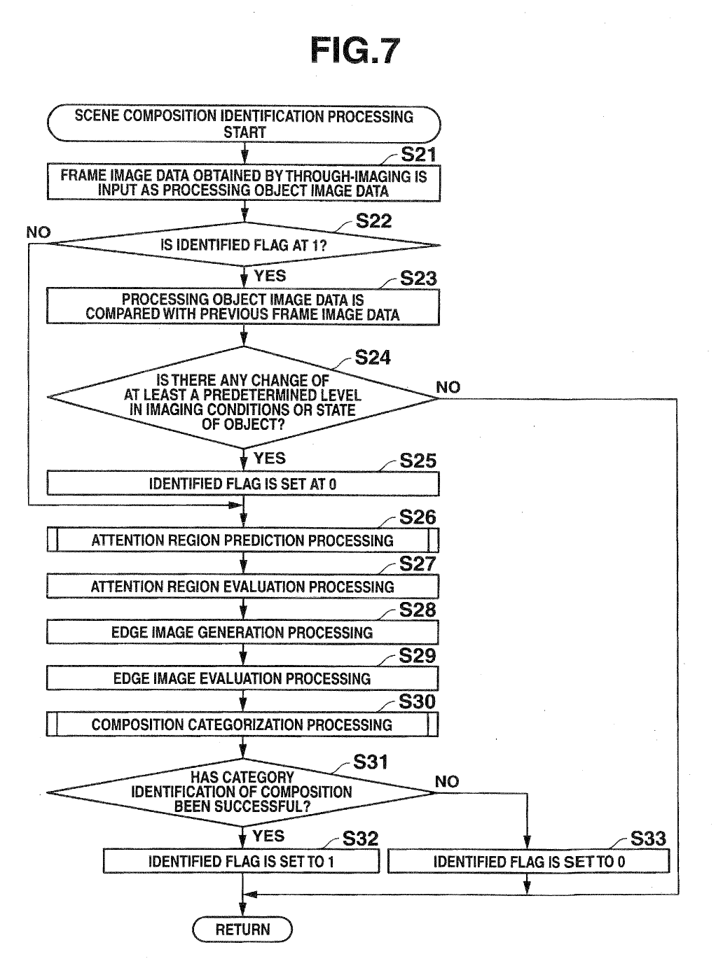

Hereinafter, the above-described sequence of processing from step Sa to step Sc is referred to as “attention region prediction processing”. The attention region prediction processing corresponds to the processing of step S26 in FIG. 7, which is described later. Details of the attention region prediction processing are described later with reference to FIG. 8 to FIG. 10.

Next, in step Sd, the CPU 9 executes, for example, the following processing to serve as attention region evaluation processing.

That is, the CPU 9 performs an evaluation in relation to attention regions (in the example of FIG. 2, the attention region 52). More specifically, for example, the CPU 9 performs respective evaluations for the attention regions of areas, number, distribution range spreads, dispersion, degrees of isolation and the like.

The processing of step Sd corresponds to the processing of step S27 in FIG. 7, which is described later.

Meanwhile, in step Se, the CPU 9 performs, for example, processing as follows to serve as edge image generation processing.

That is, the CPU 9 applies averaging processing and edge filter processing to the through-image 51, thereby generating an edge image (an outline image). For example, in the example of FIG. 2, an edge image 53 is obtained.

The processing of step Se corresponds to the processing of step S28 in FIG. 7, which is described later.

In step Sf, the CPU 9 executes, for example, processing as follows to serve as edge image evaluation processing.

That is, the CPU 9 performs tests to extract linear components, curvilinear components and edge (outline) components from the edge image. Then, the CPU 9 performs various evaluations on each of the extracted components, for example, of numbers, line lengths, positional relationships, distribution conditions and the like. For example, in the example of FIG. 2, an edge component SL and the like are extracted, and evaluations thereof are performed.

The processing of step Sf corresponds to the processing of step S29 in FIG. 7, which is described later.

Then, in step Sg, the CPU 9 performs, for example, processing as follows to serve as composition element extraction processing of the through-image 51.

That is, the CPU 9 uses the evaluation results of the attention region evaluation processing of step Sd and the evaluation results of the edge image evaluation processing of step Sf, and extracts a pattern of arrangement of composition elements of principal objects that would attract attention among objects contained in the through-image 51.

The composition elements themselves are not particularly limited. For example, in the present embodiment, attention regions, various lines (including lines that are edges), and faces of people are utilized.

Types of arrangement pattern are also not particularly limited. For example, in the present embodiment, for attention regions, the following are utilized as arrangement patterns: “a distribution that is spread over the whole image”, “a vertical split”, “a horizontal distribution”, “a vertical distribution”, “an angled split”, “a diagonal distribution”, “a substantially central distribution”, “a tunnel shape below the center”, “symmetry between left and right”, “parallelism between left and right”, “distribution in a number of similar shapes”, “dispersed”, “isolated”, and so forth. For each type of line, the following are utilized as arrangement patterns: present or absent, long or short, a tunnel shape below the center, the presence of a number of lines of the same type in substantially the same direction, lines radially extending up and down/left and right roughly from the center, lines radially extending from the top or the bottom, and so forth. For faces of people, whether or not the same are included in principal elements is utilized as an arrangement pattern.

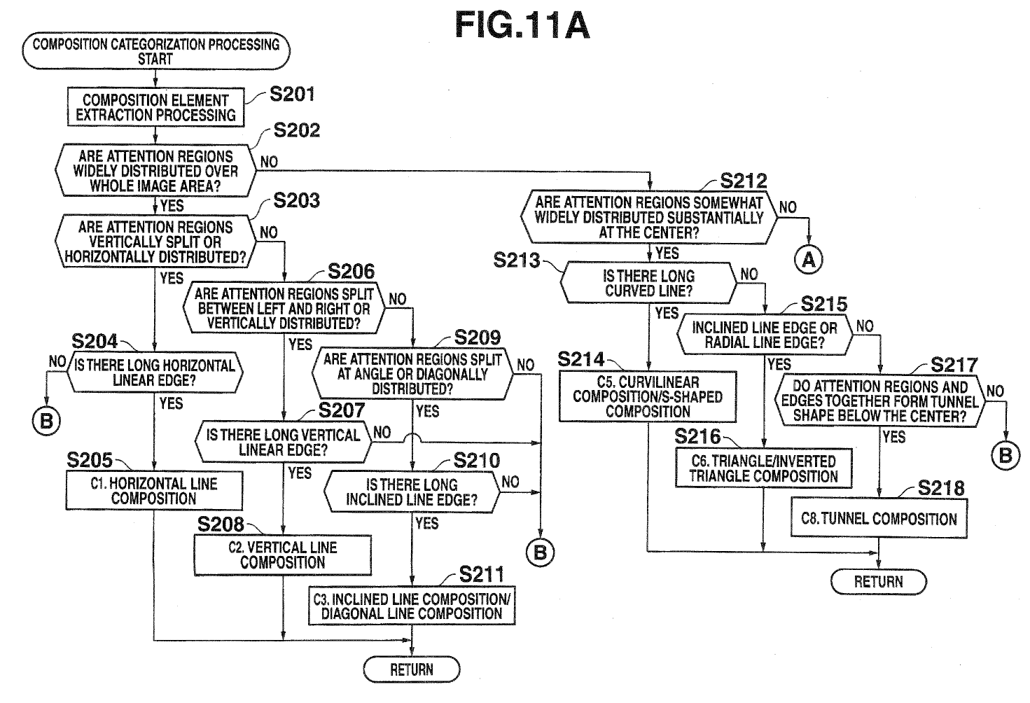

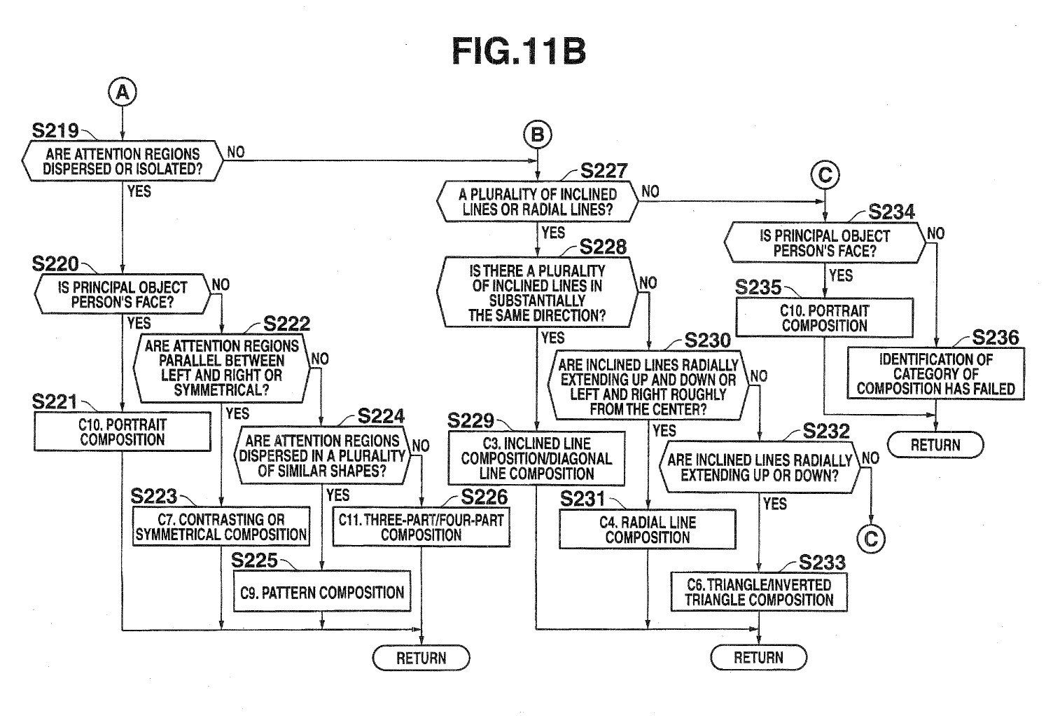

The processing of step Sg corresponds to the processing of step S201 in the composition categorization processing of FIG. 11A, which is described later. That is, the processing of step Sg is drawn as being separate from the processing of step Sh in the example of FIG. 2, but is part of the processing of step Sh in the present embodiment. Of course, the processing of step Sg can easily be made to be processing that is separate from the processing of step Sh.

In step Sh, the CPU 9 executes, for example, processing as follows to serve as the composition categorization processing.

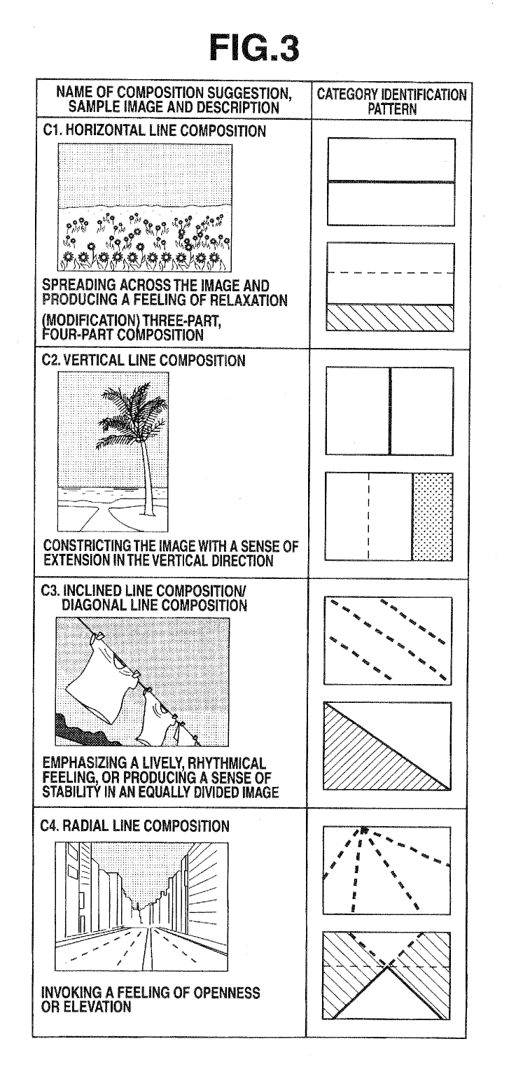

That is, for each of a plurality of composition suggestions, a predetermined pattern capable of identifying the individual model composition suggestion (hereinafter referred to as a “category identification pattern”) is stored in advance in the ROM 11 or the like. Detailed examples of category identification patterns are described below with reference to FIG. 3 and FIG. 4.

In this case, the CPU 9 compares and checks the arrangement pattern of the composition elements of principal objects contained in the through-image 51 against each of the category identification patterns of the plurality of model composition suggestions, one by one. Then, on the basis of results of the comparison checking, the CPU 9 selects P candidates for model composition suggestions (hereinafter referred to as “model composition suggestion candidate(s)”) that resemble the through-image 51 from the plurality of model composition suggestions. P is an integer value that is at least 1, being an integer value that may be arbitrarily specified by a designer or the like. For example, in the example of FIG. 2, composition C3, “an inclined line composition/diagonal line composition”, and composition C4, a “radial line composition”, or the like are selected, and are outputted as category results.

The processing of step Sh corresponds to the processing from step S202 onward in composition categorization processing of FIG. 11A, which is described later.

FIG. 3 and FIG. 4 illustrate an example of table information in which various kinds of information are stored for each of the model composition suggestions, which is used in the composition categorization processing of step Sh.

For example, in the present embodiment, the table information illustrated in FIG. 3 and FIG. 4 is stored in advance in the ROM 11.

In the table information of FIG. 3 and FIG. 4, fields are provided for a name, a sample image and a description of each composition suggestion, and for category identification patterns. In the table information of FIG. 3 and FIG. 4, one particular row corresponds to one particular model composition suggestion.

Therefore, in the fields in the same row, information of the field names and contents thereof, which is to say the name, sample image (image data), description (text data) and category identification patterns, are each stored for a particular model composition suggestion.

In the category identification pattern field, the heavy lines show composition elements that are “edges”, and the dotted lines show composition elements that are “lines”. The shaded or dotted grey regions show composition elements that are attention regions. If the result of the composition element extraction processing of step Sg in FIG. 2 is an image 54 (image data) as shown in FIG. 2, the category identification patterns are also saved as an image (image data) as shown in FIG. 3.

Alternatively, if the result of the composition element extraction processing information representing composition elements as described above and information representing details of an arrangement pattern thereof, the category identification patterns are saved as information representing details of composition elements and arrangement patterns. More specifically, for example, a category identification pattern of composition C1 in the first row (a horizontal line composition) is saved as information in the form of “long horizontal linear edges present”, “attention region with a distribution spread over the whole image”, “attention region with a distribution in the horizontal direction”, and “long horizontal lines present”.

It should be noted that FIG. 3 and FIG. 4 merely illustrate a subset of model composition suggestions to be used in the present embodiment. Hereinafter, the following model composition suggestions C0 to C12 are utilized in the present embodiment. The elements in parentheses in the following paragraph each shows a reference symbol Ck and the name and description of a composition suggestion for a model composition suggestion Ck (k is any integer value from 0 to 12).

(C0, central point composition, concentrated to emphasize the presence of the object)

(C1, horizontal line composition, spreading across the image and producing a feeling of relaxation)

(C2, vertical line composition, constricting the image with a sense of extension in the vertical direction)

(C3, inclined line composition/diagonal line composition, producing a lively, rhythmical feeling, or producing a sense of stability in an equally divided image)

(C4, radial line composition, invoking a feeling of openness, elevation or liveliness)

(C5, curvilinear composition/S-shaped composition, bringing gracefulness or calmness to the image)

(C6, triangle/inverted triangle composition, showing stability, firmness and solid strength, or expressing vitality spreading upward or a sense of openness)

(C7, contrasting or symmetrical composition, expressing stress or a relaxed sense of tranquility)

(C8, tunnel composition, providing concentration or relaxation to the image)

(C9, pattern composition, producing a feeling of rhythm or unity with a repeating pattern)

(C10, portrait composition, . . . )

(C11, three-part/four-part composition, the most popular composition, gives photographs with good balance)

(C12, perspective composition, depending on natural forms, emphasizes distance or depth)

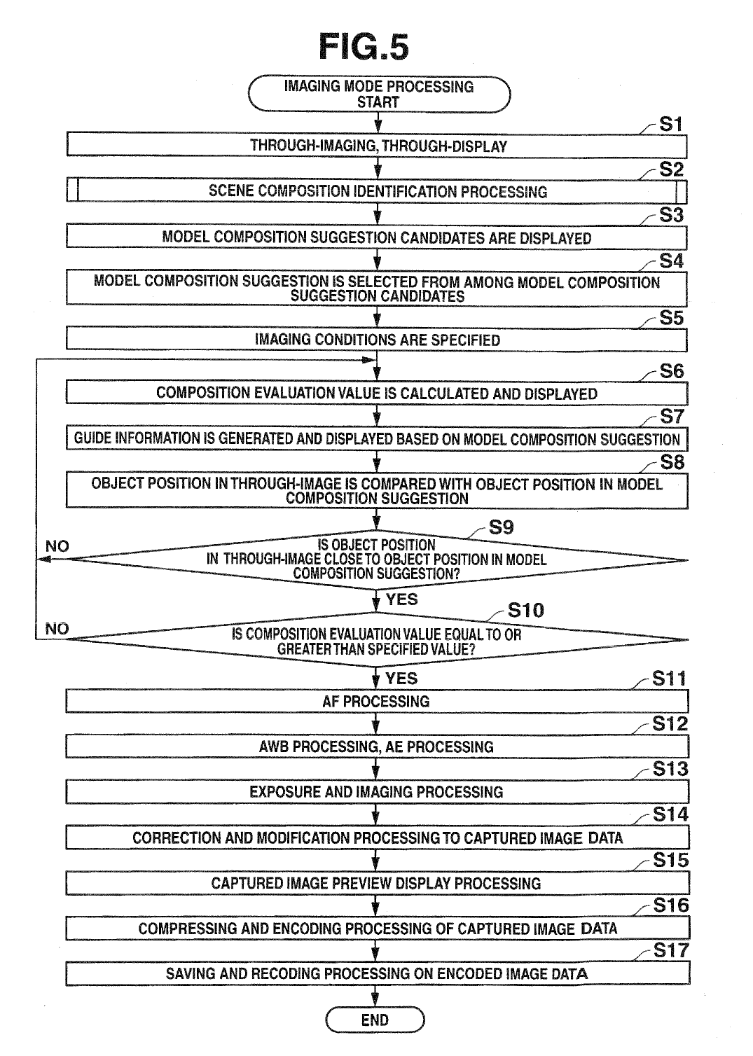

Above, the scene composition identification processing executed by the image processing device 100 is described in summary with reference to FIG. 2 to FIG. 4. Next, imaging mode processing as a whole, which includes this scene composition identification processing, is described with reference to FIG. 5 to FIGS. 11A and 11B.

FIG. 5 is a flowchart illustrating an example of a flow of the imaging mode processing.

When a user performs a predetermined operation to select the imaging mode operating the operation section 14, the imaging mode processing is triggered by this operation and starts. This means that the following processing is executed.

In step S1, the CPU 9 performs through-imaging and through-display.

In step S2, the scene composition identification processing is executed, thereby selecting P model composition suggestion candidates. The scene composition identification processing in general is as described above with reference to FIG. 2, and the details thereof are as described below with reference to FIG. 7.

In step S3, by controlling the liquid crystal display controller 12 and the like, the CPU 9 causes the P selected model composition suggestion candidates to be displayed on the liquid crystal display 13. More precisely, for each of the P model composition suggestion candidates, respective specifiable information (for example, the sample image and the name, etc.) is displayed on the liquid crystal display 13.

In step S4, the CPU 9 selects a model composition suggestion from the P model composition suggestion candidates. In step S5, the CPU 9 specifies imaging conditions.

In step S6, the CPU 9 calculates a composition evaluation value of the model composition suggestion in respect to the current through-image. Then, by controlling the liquid crystal display controller 12 and the like, the CPU 9 causes the composition evaluation value to be displayed on the liquid crystal display 13. The composition evaluation value is calculated on the basis of, for example, results of comparisons of degrees of difference, dispersion, similarity, and correlation, or the like between the through-image and the model composition suggestion with pre-specified index values of the same.

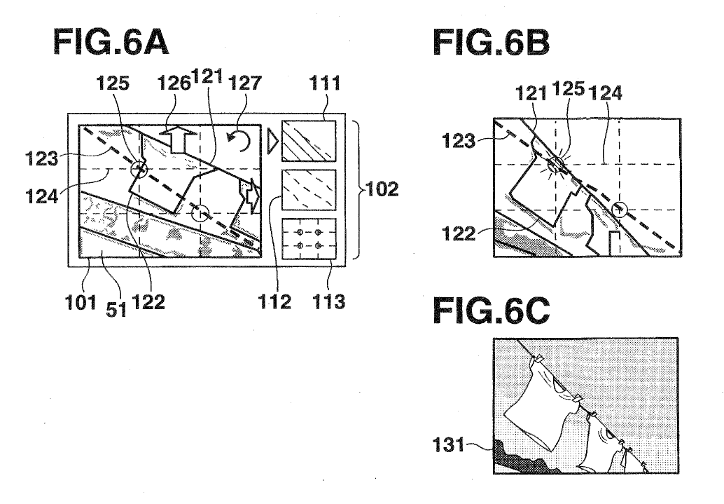

In step S7, the CPU 9 generates guide information based on the model composition suggestion. Then, by controlling the liquid crystal display controller 12 and the like, the CPU 9 causes the guide information to be displayed on the liquid crystal display 13. A specific display example of the guide information is described later with reference to FIG. 6.

In step S8, the CPU 9 compares an object position in the through-image with an object position in the model composition suggestion. In step S9, on the basis of the result of this comparison, the CPU 9 determines whether or not the object position in the through-image is close to the object position in the model composition suggestion.

If the object position in the through-image is disposed far from the object position in the model composition suggestion, it is not yet time for image processing, the determination of step S9 is negative, the processing returns to step S6, and the processing subsequent thereto is repeated. Furthermore, whenever the determination of step S9 is negative, changes in composition (framing), which is described later, is carried out and, accordingly, the display of the composition evaluation value and the guide information is continuously updated.

Hence, at a point in time at which the object position in the through-image is close to the object position in the model composition suggestion, it is assumed that the time for image processing has arrived, the determination of step S9 is affirmative, and the processing advances to step S10. In step S10, the CPU 9 determines whether or not the composition evaluation value is equal to or greater than a specified value.

If the composition evaluation value is less than the specified value, it is assumed that the through-image does not yet have a suitable composition, the determination of step S10 is negative, the processing returns to step S6, and the subsequent processing is repeated. In this case, although not illustrated in FIG. 5, for example, a model composition suggestion that is closest to the through-image (the arrangement pattern of the principal objects thereof) at this point in time and a model composition suggestion that can give a composition evaluation value higher than the specified value, or the like, are displayed on the liquid crystal display 13 or a viewfinder (not illustrated in FIG. 1). Thereinafter, if a new model composition suggestion among these model composition suggestions is approved or selected by a user, guide information for changing the imaging composition by guiding the user to positional relationships of the newly approved/selected model composition suggestion is displayed on the liquid crystal display 13 or viewfinder. In this case, the processing from step S6 onward is executed for the newly approved/selected model composition suggestion.

Thereinafter, when a time for imaging processing is again reached, that is, when the determination of the processing of step S9 is again affirmative, if the composition evaluation value is equal to or greater than the specified value, it is assumed that the through-image has a suitable composition, the determination of step S10 is affirmative, and the processing advances to step S11. Then, by the processing of step S11 being executed as follows, automatic imaging with a composition corresponding to the model composition suggestion for that moment in time is implemented.

That is, in step S11, the CPU 9 executes automatic focus (AF) processing in accordance with imaging conditions and the like (autofocus processing). In step S12, the CPU 9 executes automatic white balance (AWB) processing (auto white balance processing) and automatic exposure (AE) processing (autoexposure processing). That is, the aperture, exposure duration, flash conditions and the like are set on the basis of photometry information from the photometry sensor 17, the imaging conditions and such.

In step S13, the CPU 9 controls the TG 6 and the DSP 8, and executes exposure and imaging processing on the basis of the imaging conditions and the like. By this exposure and imaging processing, an object image is captured by the CMOS sensor 4 in accordance with imaging conditions and the like, and is stored in the DRAM 7 as frame image data. Hereinafter, this frame image data is referred to as “captured image data”, and the image represented by the captured image data is referred to as a “captured image(s)”.

In step S14, the CPU 9 controls the DSP 8 and the like, and applies correction and modification processing to the captured image data. In step S15, the CPU 9 controls the liquid crystal display controller 12 and the like, and executes preview display processing of the captured image. In step S16, the CPU 9 controls the DSP 8 and the like, and executes compression and encoding processing of the captured image data. As a result, encoded image data is obtained. Then, in step S17, the CPU 9 executes saving and recording processing on the encoded image data. Thus, the encoded image data is recorded onto the memory card 15 or the like, and the imaging mode processing ends.

It should be noted that, as the saving and recording processing of the encoded image data, the CPU 9 may record information on the model composition suggestion, the composition evaluation value and the like that are selected or calculated at the time of imaging, in addition to the scene mode and imaging conditions data at the time of imaging and the like, to the memory card 15 in association with the encoded image data. Hence, when a user is searching for a captured image, in addition to the scene and imaging conditions or the like, the user may utilize the image composition and the quality level of the composition evaluation value or the like of the captured image. Thus, users may quickly search for a desired image.

FIG. 6A to FIG. 6C illustrate specific processing results of the imaging mode processing of FIG. 5.

FIG. 6A shows an example of a display at the liquid crystal display 13 after the processing of step S7. It should be noted that a display the same as that at the liquid crystal display 13 is implemented in the viewfinder, which is not shown in FIG. 1. As illustrated in FIG. 6A, a main display region 101 and a sub display region 102 are provided on the liquid crystal display 13.

In the example in FIG. 6A, the through-image 51 is displayed in the main display region 101.

As assistance information, a guideline 121, which is close to an attention region in the through-image 51, an outline line 122 of an object in the periphery of the attention region, and the like are also displayed in the main display region 101, so as to be distinguishable from other details. Herein, this assistance information is not to be particularly limited to the guidelines 121 and the outline lines 122. For example, graphics representing outline shapes of attention regions (principal objects) or positions thereof, a distribution or an arrangement pattern thereof, or assistance lines representing positional relationships thereof may be displayed in the main display region 101.

A reference line 123, index lines 124 of the model composition suggestion, and a symbol 125 may also be displayed in the main display region 101 as guide information. The reference line 123 corresponds to a line of composition elements in the model composition suggestion, and the symbol 125 represents a moving target of the attention region. Herein, this guide information is not to be particularly limited to the reference line 123, the index lines 124 and the symbol 125 or the like. For example, graphics representing outline shapes of principal objects in the model composition suggestion or positions thereof, a distribution or an arrangement pattern thereof, or assistance lines representing positional relationships thereof may be displayed in the main display region 101.

An arrow 126 and an arrow 127 or the like may also be displayed as guide information in the main display region 101. The arrow 126 indicates a frame translation direction and the arrow 127 indicates a frame rotation direction. That is, the arrows 126 and 127 or the like are guide information that causes the user to change the composition by guiding the user to move the position of a principal object in the through-image 51 to the position of an object in the model composition suggestion (for example, the position of the symbol 125). This guide information is not to be particularly limited to the arrows 126 and 127. As another example, messages such as “Point the camera a little to the right.” and the like may be employed.

Information sets 111, 112 and 113 are displayed in the sub display region 102.

In the example of FIG. 6A, the model composition suggestion selected by the processing of step S4 in FIG. 5 is set as, for example, the model composition suggestion corresponding to the information set 111.

In addition, for example, the information set 112 and information set 113 are displayed after the determination of step S10 is negative when the composition evaluation value is less than the specified value. As a more specific example, the information set 112 and information set 113 may be information representing a model composition suggestion that is close to the through-image or information representing a model composition suggestion with a composition evaluation value higher than the specified value, or the like.

Therefore, when the composition evaluation value is less than the specified value or the like, the user may select and set one desired information set from among the information sets 111 to 113 representing model composition suggestions, by operation of the operation section 14. Then, the CPU 9 applies the processing of step S6 to step S10 to the model composition suggestion corresponding to the information that is set by the user.

From the display state of FIG. 6A, changes of composition, automatic framing and the like are carried out, and the results become the display state of FIG. 6B. That is, the composition is modified until the position of a principal object in the through-image 51 matches the position of the symbol 125. In this case, the determination of the processing of step S9 of FIG. 5 is affirmative. Accordingly, if the composition evaluation value is equal to or greater than the specified value, the determination of the processing of step S10 is affirmative and the processing of step S11 to step S17 is executed. Thus, automatic imaging with the composition illustrated in FIG. 6B is carried out. As a result thereof, a review display of a captured image 131 illustrated in FIG. 6C is implemented, and an encoded image data corresponding to the captured image 131 is recorded to the memory card 15.

Herein, although not illustrated in the example of FIG. 5, the user may of course cause the CPU 9 to execute imaging processing by pressing the shutter release button with their finger or such. In this case, the user may manually move the composition in accordance with the guide information illustrated in FIG. 6A, and fully press the shutter release button when the composition illustrated in FIG. 6B is reached. As a result, the review display of the captured image 131 illustrated in FIG. 6C is implemented and an encoded image data corresponding to the captured image 131 is recorded to the memory card 15.

Next, a detailed example of the scene composition identification processing of step S2 of the imaging mode processing of FIG. 5 is described.

FIG. 7 is a flowchart illustrating a detailed example of the flow of the scene composition identification processing.

In step S21, the CPU 9 inputs frame image data obtained by through-imaging to serve as processing object image data.

In step S22, the CPU 9 determines whether or not an identified flag is at 1. The meaning of the term “identified flag” includes a flag that represents whether or not a model composition suggestion candidate has been selected (identified) for previous frame image data. Therefore, in a case in which the identified flag=0, no model composition suggestion candidate has been selected for previous frame image data. Therefore, in a case in which the identified flag=0, the determination of step S22 is negative, the processing advances to step S26, and subsequent processing is executed. Thus, a model composition suggestion candidate is selected for the processing object image data. The processing subsequent to step S26 is described in detail later.

On the other hand, in a case in which the identified flag=1, a model composition suggestion candidate has been selected for previous frame image data. Therefore, there may be no need to select a model composition suggestion candidate for the processing object image data. This means that the CPU 9 has to determine whether or not to execute the processing subsequent to step S26. Therefore, in a case in which the identified flag=1, the determination of step S22 is affirmative, the processing advances to step S23, and processing as follows is executed.

In step S23, the CPU 9 compares the processing object image data with the previous frame image data. In step S24, the CPU 9 determines whether or not there is a change of at least a predetermined level in imaging conditions or the state of an object. If there is not a change of at least the predetermined level in the imaging conditions and the object state, the determination of step S24 is negative, and the scene composition identification processing ends without the processing subsequent to step S25 being executed.

On the other hand, if there is a change of at least the predetermined level in one or both of the imaging conditions and the object state, the determination of step S24 is affirmative, and the processing passes to step S25. In step S25, the CPU 9 changes the identified flag to 0. Therefore, the processing subsequent to step S26 as follows is executed.

In step S26, the CPU 9 executes the attention region prediction processing. That is, processing corresponding to the above-described steps Sa to Sc of FIG. 2 is executed. Thus, as described above, an attention region of the processing object image data is obtained. A detailed example of the attention region prediction processing is described later with reference to FIG. 8 to FIG. 10C.

In step S27, the CPU 9 executes the attention region evaluation processing. That is, processing corresponding to the above-described step Sd of FIG. 2 is executed.

In step S28, the CPU 9 executes the edge image generation processing. That is, processing corresponding to the above-described step Se of FIG. 2 is executed. Thus, as described above, an edge image of the processing object image data is obtained.

In step S29, the CPU 9 executes the edge image evaluation processing. That is, processing corresponding to the above-described step Sf of FIG. 2 is executed.

In step S30, the CPU 9 executes the composition categorization processing, using the results of the attention region evaluation processing and the results of the edge image evaluation processing. That is, processing corresponding to the above-described step Sh (including step Sg) of FIG. 2 is executed. A detailed example of the composition categorization processing is described later with reference to FIGS. 11A and 11B.

In step S31, the CPU 9 determines whether or not category identification of the composition has been successful.

If a model composition suggestion candidate is selected with P=1 or more in the processing of step S30, the determination of step S31 is affirmative and the processing advances to step S32. In step S32, the CPU 9 sets the identified flag to 1.

On the other hand, if a model composition suggestion candidate is not selected in the processing of step S30, the determination of step S31 is negative and the processing passes to step S33. In step S33, the CPU 9 sets the identified flag to 0.

When the identified flag has been set to 1 in the processing of step S32 or set to 0 in the processing of step S33, the scene composition identification processing ends, i.e. the processing of step S2 of FIG. 5 ends, the processing advances to step S3, and subsequent processing is executed.

Next, a detailed example of the attention region prediction processing of step S26 (step Sa to Sc of FIG. 2) in the scene composition identification processing of FIG. 7 is described.

As described above, in the attention region prediction processing, the saliency map is created in order to predict the attention region. Accordingly, Treisman's feature integration theory and a saliency map according to Nitti and Koch et al. or the like can be employed for the attention region prediction processing.

For Treisman's feature integration theory, refer to “A feature-integration theory of attention”, A. M. Treisman and G. Gelade, Cognitive Psychology, Vol. 12, No. 1, pp. 97-136, 1980. In addition, for the saliency map according to Nitti and Koch et al., refer to “A Model of Saliency-Based Visual Attention for Rapid Scene Analysis”, L. Itti, C. Koch, and E. Niebur, IEEE Transactions on Pattern Analysis and Machine Intelligence, Vol. 20, No. 11, November 1998.

FIG. 8 is a flowchart illustrating a detailed example of a flow of the attention region prediction processing for a case in which Treisman's feature integration theory and a saliency map according to Nitti and Koch et al. or the like are employed.

In step S41, the CPU 9 acquires processing object image data. Herein, the meaning of the processing object image data that is acquired here includes the processing object image data that is inputted in the processing of step S21 of FIG. 7.

In step S42, the CPU 9 creates a Gaussian resolution pyramid. More specifically, for example, the CPU 9 successively and repetitively executes Gaussian filter processing and downsampling processing with the processing object image data {pixel data for positions (x, y)} set to I(0)=I(x, y). As a result, sets of hierarchical scale image data I(L) (for example, Lε{0 . . . 8}) are generated. The sets of this hierarchical scale image data I(L) are referred to as the “Gaussian resolution pyramid”. When the scale L is k (k is any integer from 1 to 8), the scale image data I(k) represents an image reduced by ½^{k} (in a case of k=0, the original image).

In step S43, the CPU 9 begins feature quantity map creation processing. A detailed example of the feature quantity map creation processing is described later with reference to FIG. 9A to FIG. 9C and FIG. 10A to FIG. 10C.

In step S44, the CPU 9 determines whether or not all of the feature quantity map creation processing has finished. If the processing of even one of the feature quantity map creation processing has not finished, the determination of step S44 is negative and the processing returns to step S44 again. That is, the determination processing of step S44 is repeatedly executed until all processing of the feature quantity map creation processing is finished. Then, when all processing of the feature quantity map creation processing is finished and all of the feature quantity maps are created, the determination of step S44 is affirmative and the processing advances to step S45.

In step S45, the CPU 9 combines the feature quantity maps by linear addition and obtains a saliency map S.

In step S46, the CPU 9 uses the saliency map S to predict attention regions from the processing object image data. In general, it is thought that people who are principal objects and items that are objects of imaging have higher saliency than background regions. Accordingly, the CPU 9 uses the saliency map S to identify regions with high saliency from the processing object image data. Then, on the basis of these identification results, the CPU 9 predicts regions with a high probability of drawing the visual attention of a person, which is to say, attention regions. When attention regions have been predicted, the attention region prediction processing ends. That is, the processing of step S26 of FIG. 7 ends and the processing advances to step S27. In the context of the example of FIG. 2, the processing sequence of steps Sa to Sc ends and the processing advances to step Sd.

Next, a specific example of the feature quantity map creation processing is described.

FIG. 9A, FIG. 9B and FIG. 9C are flowcharts illustrating an example of flows of feature quantity map creation processing of luminance, color and orientation.

FIG. 9A illustrates an example of feature quantity map creation processing for luminance.

In step S61, the CPU 9 sets respective inspection pixels in each of the scale images corresponding to the processing object image data. The following description is given with, for example, the inspection pixels specified as c ε {2, 3, 4}. The meaning of the term “inspection pixels cε{2,3,4}” includes pixels specified as calculation objects in scale image data I(c) of the scales cε{2, 3, 4}.

In step S62, the CPU 9 finds luminance components of the scale images at the inspection pixels cε{2, 3, 4}.

In step S63, the CPU 9 finds luminance components of the scale images at inspection pixel surround pixels s=c+δ. The meaning of the term “inspection pixel surround pixels s=c+δ” includes pixels that are disposed peripherally to an inspection pixel (correspondence point) in a scale image I(s) with the scale s=c+δ.

In step S64, the CPU 9 obtains luminance contrasts at respective inspection pixels cε{2, 3, 4} in each of the scale images. For example, the CPU 9 calculates inter-scale differences between the inspection pixels cε{2, 3, 4} and the inspection pixel surround pixels s=c+δ (for example, δ ε {3, 4}). Herein, if an inspection pixel c is referred to as a “center”, and an inspection pixel surround pixel s is referred to as a “surround”, an inter-scale difference that is calculated may be referred to as a “center-surround inter-scale difference of luminance”. This center-surround inter-scale difference of luminance is a characteristic that has a large value if the inspection pixels c are white and the surround pixels s are black or vice versa. Therefore, the center-surround inter-scale difference of luminance expresses luminance contrast. Herein, this luminance contrast is denoted by I(c, s) hereinafter.

In step S65, the CPU 9 determines whether or not there is a pixel that has not been specified as the inspection pixel in each of the scale images corresponding to the processing object image data. If such a pixel is present, the determination of step S65 is affirmative, the processing returns to step S61, and the subsequent processing is repeated.

That is, the processing of step S61 to step S65 is respectively applied to each pixel of the scale images corresponding to the processing object image data, and the luminance contrast I(c, s) is found for each pixel. When the inspection pixels cε{2, 3, 4} and surround pixels s=c+δ (for example, δε{3, 4}) are specified, (3 inspection pixels c)×(2 surround pixels s)=6 luminance contrasts I(c, s) are found by the processing of one repetition of step S61 to step S65. An aggregation of luminance contrasts I(c, s) over the whole image found for predetermined c and predetermined s is hereinafter referred to as a “luminance contrast I feature quantity map”. As a result of the repetitions of the processing loop from step S61 to step S65, six of the luminance contrast I feature quantity maps are obtained. When the six luminance contrast I feature quantity maps have been obtained in this manner, the determination of step S65 is negative and the processing advances to step S66.

In step S66, a luminance feature quantity map is created by combining the luminance contrast I feature quantity maps, after normalization thereof. Hence, the feature quantity map creation process for luminance ends. Herein, in order to distinguish the luminance feature quantity map from other feature quantity maps, the luminance feature quantity map is denoted with FI hereinafter.

FIG. 9B illustrates an example of feature quantity map creation processing for color.

Comparing the color feature quantity map creation processing of FIG. 9B with the luminance feature quantity map creation processing of FIG. 9A, the flow of processing is basically similar, and only the processing object is different. That is, the processing of each of step S81 to step S86 in FIG. 9B corresponds to step S61 to step S66 in FIG. 9A, respectively, and only the processing object of these steps differs from FIG. 9A. Therefore, no description is given of the flow of processing of the color feature quantity map creation processing of FIG. 9B; only the processing object is briefly described hereinafter.

That is, while the processing object of step S62 and step S63 in FIG. 9A is the luminance component, the processing object of step S82 and S83 in FIG. 9B is the color component.

In addition, in the processing of step S64 of FIG. 9A, luminance center-surround inter-scale differences are calculated as the luminance contrasts I(c, s), whereas, in the processing of step S84 of FIG. 9B, center-surround inter-scale differences of color phase (R, G, B, Y) are calculated as color phase contrasts. Herein, among the color components, red components are indicated by R, green components are indicated by G, blue components are indicated by B and yellow components are indicated by Y. Hereinafter, a color phase contrast for the color phase R/G is denoted by RG(c, s), and a color phase contrast for the color phase B/Y is denoted by BY(c, s).

In this case, as in the example described above, it is assumed that there are three inspection pixels c and there are two surround pixels s. From the results of the loop processing of step S61 to step S65 of FIG. 9A, six feature quantity maps of luminance contrasts I are obtained. In contrast, from the results of the loop processing of step S81 to step S85 of FIG. 9B, six feature quantity maps of color phase contrasts RG are obtained and six feature quantity maps of color phase contrasts BY are obtained.

Finally, in the processing of step S66 of FIG. 9A, the luminance feature quantity map FI is obtained, whereas, in the processing of step S86 of FIG. 9B, a color feature quantity map is obtained. Herein, in order to distinguish the color feature quantity map from the other feature quantity maps, the color feature quantity map is denoted with FC hereinafter.

FIG. 9C illustrates an example of feature quantity map creation processing for orientation.

Comparing the orientation feature quantity map creation processing of FIG. 9C with the luminance feature quantity map creation processing of FIG. 9A, the flow of processing is basically similar, and only the processing object is different. That is, the processing of each of step S101 to step S106 in FIG. 9C corresponds to step S61 to step S66 in FIG. 9A, respectively, and only the processing object of these steps differs from FIG. 9A. Therefore, no description is given of the flow of processing of the orientation feature quantity map creation processing of FIG. 9C; only the processing object is briefly described hereinafter.

That is, the processing object of steps S102 and S103 in FIG. 9C is the orientation component. Herein, the meaning of the term orientation component includes amplitude components in respective directions that are obtained as a result of convolution of a Gaussian filter φ with luminance components. The meaning of the term orientation here includes a direction represented by a rotational angle θ that is included as a parameter of the Gaussian filter φ. For example, the four directions 0°, 45°, 90° and 135° are employed as the rotational angle θ.

In addition, in the processing of step S104, center-surround inter-scale differences of orientation are calculated to serve as orientation contrasts. Hereinafter, an orientation contrast is denoted by O(c, s, θ).

In this case, as in the examples described above, there are three inspection pixels c and two surround pixels s. From the results of the loop processing of step S101 to step S105, six feature quantity maps of orientation contrasts O are obtained. When, for example, the four directions 0°, 45°, 90° and 135° are employed as the rotational angle θ, 24 (=6×4) feature quantity maps of orientation contrasts O are obtained.

Finally, in the processing of step S106 of FIG. 9C, an orientation feature quantity map is obtained. Herein, in order to distinguish the orientation feature quantity map from the other feature quantity maps, the orientation feature quantity map is denoted with FO hereinafter. For more details of the feature quantity map creation processing described with reference to FIG. 9, refer to, for example, “A Model of Saliency-Based Visual Attention for Rapid Scene Analysis”, L. Itti, C. Koch, and E. Niebur, IEEE Transactions on Pattern Analysis and Machine Intelligence, Vol. 20, No. 11, November 1998.

The feature quantity map creation processing herein is not to be particularly limited by the example of FIG. 9A to FIG. 9C. For example, processing that uses feature quantities of brightness, saturation, hue and motion and creates respective feature quantity maps thereof may be employed as the feature quantity map creation processing.

As a further example, processing that uses feature quantities of multi-scale contrasts, center-surround color histograms and color space distributions and creates respective feature quantity maps thereof may be employed as the feature quantity map creation processing.

FIG. 10A, FIG. 10B and FIG. 10C are flowcharts illustrating an example of flows of feature quantity map creation processing for multi-scale contrast, center-surround color histogram and color space distribution.

FIG. 10A illustrates an example of feature quantity map creation processing for multi-scale contrast.

In step S121, the CPU 9 obtains a multi-scale contrast feature quantity map. Hence, the multi-scale contrast feature quantity map creation processing ends.

Herein, in order to distinguish the multi-scale contrast feature quantity map from the other feature quantity maps, the multi-scale contrast feature quantity map is denoted with Fc hereinafter.

FIG. 10B illustrates an example of feature quantity map creation processing for center-surround color histograms.

In step S141, the CPU 9 calculates a color histogram of a rectangular region and a color histogram of a surrounding outline for each different aspect ratio. The aspect ratios themselves are not particularly limited; for example, {0.5, 0.75, 1.0, 1.5, 2.0} or the like may be employed.

In step S142, the CPU 9 finds a chi-square distance between the rectangular region color histogram and the surrounding outline color histogram, for each of the different aspect ratios. In step S143, the CPU 9 finds the rectangular region color histogram for which the chi-square distance is largest.

In step S144, the CPU 9 uses the rectangular region color histogram with the largest chi-square distance and creates a center-surround color histogram feature quantity map. Hence, the center-surround color histogram feature quantity map creation processing ends.

Herein, in order to distinguish the center-surround color histogram feature quantity map from the other feature quantity maps, the center-surround color histogram feature quantity map is denoted with Fh hereinafter.

FIG. 10C illustrates an example of feature quantity map creation processing for color space distributions.

In step S161, the CPU 9 calculates a horizontal direction dispersion of a color space distribution. In step S162, the CPU 9 calculates a vertical direction dispersion of the color space distribution. Then, in step S163, the CPU 9 uses the horizontal direction dispersion and the vertical direction dispersion to calculate a spatial dispersion of color.

In step S164, the CPU 9 uses the spatial dispersion of color to create a color space distribution feature quantity map. Hence, the color space distribution feature quantity map creation processing ends.

Herein, in order to distinguish the color space distribution feature quantity map from the other feature quantity maps, the color space distribution feature quantity map is denoted with Fs hereinafter.

For more detailed descriptions of the feature quantity map creation processing of FIG. 10A to FIG. 10C described above, for example, T. Liu, J. Sun, N. Zheng, X. Tang, and H. Sum, “Learning to Detect A Salient Object”, CVPR07, pp. 1-8, 2007, may be referred to.

Next, a detailed example of the composition categorization processing of step S30 in the scene composition identification processing of FIG. 7 is described.

FIGS. 11A and 11B are a set of flowcharts illustrating a detailed example of the flow of composition analysis processing.

In the example of FIGS. 11A and 11B, one of the aforementioned model composition suggestions C1 to C11 is to be selected as a model composition suggestion candidate. That is, in the example of FIGS. 11A and 11B, the P=1 model composition suggestion candidate is selected.

In step S201, the CPU 9 executes composition element extraction processing. That is, processing corresponding to step Sg of the above-described FIG. 2 is executed. Thus, as described above, composition elements and an arrangement pattern thereof are extracted from the processing object image data inputted in the processing of step S21 of FIG. 7.

Hence, processing from step S202 onward as follows is executed, to serve as processing corresponding to step Sh of FIG. 2 (excluding step Sg). In the example of FIG. 11A, information representing details of the composition elements and the arrangement pattern thereof are obtained as results of the processing of step S201. Therefore, the form of the category identification pattern stored in the table information of FIG. 3 and FIG. 4 is not image data as illustrated in FIG. 3 and FIG. 4, but rather information that represents details of composition elements and arrangement patterns. That is, in the processing from step S202 onward hereinafter, the composition elements and arrangement pattern thereof obtained from the results of the processing of step S201 are compared and checked against the composition elements and arrangement patterns serving as the category identification patterns.

In step S202, the CPU 9 determines whether or not the attention regions are widely distributed over the whole image area.

If it is determined in step S202 that the attention regions are not widely distributed over the whole image area, i.e. in a case in which the determination is negative, the processing advances on to step S212. The processing from step S212 onward is described later.

On the other hand, if it is determined in step S202 that the attention regions are widely spread over the whole image area, i.e. in a case in which the determination is affirmative, the processing advances to step S203. In step S203, the CPU 9 determines whether or not the attention regions are vertically split/horizontally distributed.

In step S203, in a case in which it is determined that the attention regions are neither vertically split nor horizontally distributed, i.e. in a case in which the determination is negative, the processing advances to step S206. The processing from step S206 onward is described later.

On the other hand, in a case in which it is determined in step S203 that the attention regions are vertically split or horizontally distributed, i.e. in a case in which the determination is affirmative, the processing advances to step S204. In step S204, the CPU 9 determines whether or not there are any long horizontal linear edges.

In a case in which it is determined in step S204 that there are no long horizontal linear edges, i.e. in a case in which the determination is negative, the processing advances to step S227. The processing from step S227 onward is described later.

On the other hand, in a case in which it is determined in step S204 that there is a long horizontal linear edge, i.e. in a case in which the determination is affirmative, the processing advances to step S205. In step S205, the CPU 9 selects the model composition suggestion C1, “the horizontal linear composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result thereof, the scene composition identification processing as a whole ends.

If the determination of the processing of step S203 as described above is negative, the processing advances to step S206. In step S206, the CPU 9 determines whether or not the attention regions are split between left and right or vertically distributed.

In step S206, in a case in which it is determined that the attention regions are neither split between left and right nor vertically distributed, i.e. in a case in which the determination is negative, the processing advances to step S209. The processing from step S209 onward is described later.

On the other hand, in a case in which it is determined in step S206 that the attention regions are split between left and right or vertically distributed, i.e. in a case in which the determination is affirmative, the processing advances to step S207. In step S207, the CPU 9 determines whether or not there are any long vertical linear edges.

In a case in which it is determined in step S207 that there are no long vertical linear edges, i.e. in a case in which the determination is negative, the processing advances to step S227. The processing from step S227 onward is described later.

On the other hand, in a case in which it is determined in step S207 that there is a long vertical linear edge, i.e. in a case in which the determination is affirmative, the processing advances to step S208. In step S208, the CPU 9 selects the model composition suggestion C2, “the vertical linear composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S206 as described above is negative, the processing advances to step S209. In step S209, the CPU 9 determines whether or not the attention regions are split at an angle or diagonally distributed.

In step S209, in a case in which it is determined that the attention regions are neither split at an angle nor diagonally distributed, i.e. in a case in which the determination is negative, the processing advances to step S227. The processing from step S227 onward is described later.

On the other hand, in a case in which it is determined in step S209 that the attention regions are split at an angle or diagonally distributed, i.e. in a case in which the determination is affirmative, the processing advances to step S210. In step S210, the CPU 9 determines whether or not there are any long inclined line edges.

In a case in which it is determined in step S210 that there are no long inclined line edges, i.e. in a case in which the determination is negative, the processing advances to step S227. The processing from step S227 onward is described later.

On the other hand, in a case in which it is determined in step S210 that there is a long inclined line edge, i.e. in a case in which the determination is affirmative, the processing advances to step S211. In step S211, the CPU 9 selects the model composition suggestion C3, “the inclined line composition/diagonal line composition”, as the model composition suggestion candidate. Hence, the composition categorization processing ends. Thus, the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S202 as described above is negative, the processing advances to step S212. In step S212, the CPU 9 determines whether or not the attention regions are somewhat widely distributed substantially at the center.

In step S212, in a case in which it is determined that the attention regions are not somewhat widely distributed substantially at the center, i.e. in a case in which the determination is negative, the processing advances to step S219. The processing from step S219 onward is described later.

On the other hand, in a case in which it is determined in step S212 that the attention regions are somewhat widely distributed substantially centrally, i.e. in a case in which the determination is affirmative, the processing advances to step S213. In step S213, the CPU 9 determines whether or not there are any long curved lines.

In a case in which it is determined in step S213 that there are no long curved lines, i.e. in a case in which the determination is negative, the processing advances to step S215. The processing from step S215 onward is described later.

On the other hand, in a case in which it is determined in step S213 that there is a long curved line, i.e. in a case in which the determination is affirmative, the processing advances to step S214. In step S214, the CPU 9 selects the model composition suggestion C5, “the curvilinear composition/S-shaped composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S213 as described above is negative, the processing advances to step S215. In step S215, the CPU 9 determines whether or not there are any inclined line edges or radial line edges.

In step S215, in a case in which it is determined that there are not any inclined line edges or radial line edges, i.e. in a case in which the determination is negative, the processing advances to step S217. The processing from step S217 onward is described later.

On the other hand, in a case in which it is determined in step S215 that there is an inclined edge or radial line edge, i.e. in a case in which the determination is affirmative, the processing advances to step S216. In step S216, the CPU 9 selects the model composition suggestion C6, “the triangle/inverted triangle composition”, as the model composition suggestion candidate. Hence, the composition categorization processing ends. This means that, the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S215 as described above is negative, the processing advances to step S217. In step S217, the CPU 9 determines whether or not the attention regions and the edges together form a tunnel shape below the center.

In step S217, in a case in which it is determined that the attention regions and the edges together do not form a tunnel shape below the center, i.e. in a case in which the determination is negative, the processing advances to step S227. The processing from step S227 onward is described later.

On the other hand, in a case in which it is determined in step S217 that the attention regions and the edges together form a tunnel shape below the center, i.e. in a case in which the determination is affirmative, the processing advances to step S218. In step S218, the CPU 9 selects the model composition suggestion C8, “the tunnel composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S212 as described above is negative, the processing advances to step S219. In step S219, the CPU 9 determines whether or not the attention regions are dispersed or isolated.

In step S219, in a case in which it is determined that the attention regions are not dispersed or isolated, i.e. in a case in which the determination is negative, the processing advances to step S227. The processing from step S227 onward is described later.

On the other hand, in a case in which it is determined in step S219 that the attention regions are dispersed or isolated, i.e. in a case in which the determination is affirmative, the processing advances to step S220. In step S220, the CPU 9 determines whether or not a principal object is a person's face.

In step S220, in a case in which it is determined that the principal object is not a person's face, i.e. in a case in which the determination is negative, the processing advances to step S222. The processing from step S222 onward is described later.

On the other hand, in a case in which it is determined in step S220 that the principal object is a person's face, i.e. in a case in which the determination is affirmative, the processing advances to step S221. In step S221, the CPU 9 selects the model composition suggestion C10, “the portrait composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S220 as described above is negative, the processing advances to step S222. In step S222, the CPU 9 determines whether or not the attention regions are parallel between left and right or symmetrical.

In step S222, in a case in which it is determined that the attention regions are not parallel between left and right or symmetrical, i.e. in a case in which the determination is negative, the processing advances to step S224. The processing from step S224 onward is described later.

On the other hand, in a case in which it is determined in step S222 that the attention regions are parallel between left and right or symmetrical, i.e. in a case in which the determination is affirmative, the processing advances to step S223. In step S223, the CPU 9 selects the model composition suggestion C7, the“contrasting or symmetrical composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S222 as described above is negative, the processing advances to step S224. In step S224, the CPU 9 determines whether or not the attention regions or outlines are dispersed in a plurality of similar shapes.

In step S224, in a case in which it is determined that the attention regions or outlines are dispersed in a plurality of similar shapes, i.e. in a case in which the determination is affirmative, the processing advances to step S225. In step S225, the CPU 9 selects the model composition suggestion C9, “the pattern composition” as the model composition suggestion candidate.

On the other hand, in a case in which it is determined in step S224 that the attention regions and outlines are not in a plurality of similar shapes or are not dispersed, i.e. in a case in which the determination is negative, the processing advances to step S226. In step S226, the CPU 9 selects the model composition suggestion C11, “the three-part/four-part composition”, as the model composition suggestion candidate.

When the processing of step S225 or step S226 ends, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of any of the processing of step S204, S207, S209, S210, S217 or S219 as described above is negative, the processing advances to step S227. In step S227, the CPU 9 determines whether or not there is a plurality of inclined lines or radial lines.

In step S227, in a case in which it is determined that there is not a plurality of inclined lines or radial lines, i.e. in a case in which the determination is negative, the processing advances to step S234. The processing from step S234 onward is described later.

On the other hand, in a case in which it is determined in step S227 that there is a plurality of inclined lines or radial lines, i.e. in a case in which the determination is affirmative, the processing advances to step S228. In step S228, the CPU 9 determines whether or not there is a plurality of inclined lines substantially in the same direction.

In step S228, in a case in which it is determined that there is not a plurality of inclined lines substantially in the same direction, i.e. in a case in which the determination is negative, the processing advances to step S230. The processing from step S230 onward is described later.

On the other hand, in a case in which it is determined in step S228 that there is a plurality of inclined lines substantially in the same direction, i.e. in a case in which the determination is affirmative, the processing advances to step S229. In step S229, the CPU 9 selects the model composition suggestion C3, “the inclined line composition/diagonal line composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S228 as described above is negative, the processing advances to step S230. In step S230, the CPU 9 determines whether or not the inclined lines are lines radially extending up and down or left and right roughly from the center.

In step S230, in a case in which it is determined that the inclined lines are not lines radially extending up and down roughly from the center and are not lines radially extending left and right roughly from the center, i.e. in a case in which the determination is negative, the processing advances to step S232. The processing from step S232 onward is described later.

On the other hand, in a case in which it is determined in step S230 that the inclined lines are lines radially extending up and down or left and right roughly from the center, i.e. in a case in which the determination is affirmative, the processing advances to step S231. In step S231, the CPU 9 selects the model composition suggestion C4, “the radial line composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

If the determination of the processing of step S230 as described above is negative, the processing advances to step S232. In step S232, the CPU 9 determines whether or not the inclined lines are lines radially extending from the top or the bottom.

In step S232, in a case in which it is determined that the inclined lines are not lines radially extending from the top and are not lines radially extending from the bottom, i.e. in a case in which the determination is negative, the processing advances to step S234. The processing from step S234 onward is described later.

On the other hand, in a case in which it is determined in step S232 that the inclined lines are lines radially extending from the top or the bottom, i.e. in a case in which the determination is affirmative, the processing advances to step S233. In step S233, the CPU 9 selects the model composition suggestion C6, “the triangle/inverted triangle composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. Hence, the scene composition identification processing as a whole ends.

If the determination of the processing of step S227 or step S232 as described above is negative, the processing advances to step S234. In step S234, the CPU 9 determines whether or not a principal object is a person's face.

In a case in which it is determined in step S234 that the principal object is a person's face, i.e. in a case in which the determination is affirmative, the processing advances to step S235. In step S235, the CPU 9 selects the model composition suggestion C10, “the portrait composition”, as the model composition suggestion candidate. Hence, the composition categorization processing ends. This means that the processing of step S30 of FIG. 7 ends, the determination in the processing of step S31 is affirmative, and the identified flag is set to 1 in the processing of step S32. As a result, the scene composition identification processing as a whole ends.

On the other hand, in a case in which it is determined in step S234 that the principal object is not a person's face, i.e. in a case in which the determination is negative, the processing advances to step S236. In step S236, the CPU 9 judges that identification of the category of the composition has failed. Hence, the composition categorization processing ends. This means that the processing of step S30 of FIG. 7 ends, the determination in the processing of step S31 is negative, and the identified flag is set to 0 in the processing of step S33. As a result, the scene composition identification processing as a whole ends.

As described above, the CPU 9 of the image processing device 100 relating to the first embodiment includes a function that predicts attention regions for an input image including principal objects, based on a plurality of feature quantities extracted from the input image. The CPU 9 includes a function that, using the attention regions, identifies a model composition suggestion similar to the input image in regard to arrangement states of principal objects (for example, an arrangement pattern, positional relationships or the like) from among a plurality of model composition suggestions.

Since the model composition suggestion identified in this manner is similar to the input image (through-image) in regard to arrangement states of principal objects (for example, an arrangement pattern, positional relationships or the like), the model composition suggestion may be considered as a composition suggestion that is ideal for the input image, an attractive composition suggestion or the like. Therefore, when these composition suggestions are exhibited to users and accepted, it is possible for the users to perform imaging of various objects and common scenes with ideal compositions and attractive compositions.

In the function of the CPU 9 relating to the first embodiment that identifies a composition suggestion, a function is included that uses line components of an edge image corresponding to the input image, in addition to the attention regions, to identify a model composition suggestion similar to the input image in regard to arrangement states of principal objects (for example, an arrangement pattern, positional relationships or the like).

When this functionality is employed, a great variety of model composition suggestions, beside simple composition suggestions in which objects are placed at intersections of a conventional golden section grid (three-part lines), may also be exhibited as composition suggestions. As a result, the model composition suggestions exhibited as model composition suggestions are not stereotypical compositions, and users can capture principal objects with a great variety of compositions in accordance with scenes and objects, with various flexible compositions.

The CPU 9 relating to the first embodiment further includes a function that exhibits the identified model composition suggestion. Therefore, a model composition suggestion when capturing a common principal object other than the face of a person may be exhibited simply by a user tracking the principal object while looking at the input image (through-image) in the viewfinder or the like. Therefore, a user may evaluate the acceptability of a composition on the basis of the exhibited model composition suggestion. Furthermore, when a scene changes, a plurality of model composition suggestions may be exhibited for each scene. Thus, a user may select from the plurality of model composition suggestions that are exhibited a desired composition suggestion to serve as the composition at the moment of imaging.

The CPU 9 relating to the first embodiment further includes a function that performs an evaluation of an identified model composition suggestion. The function of exhibition includes a function that exhibits a result of this evaluation together with the identified model composition suggestion. Thus, the CPU 9 may continuously identify model composition suggestions in accordance with changes in composition (framing), and these evaluations may be performed continuously. Therefore, by utilizing the continuously changing evaluations, a user may look for better compositions for the input image and easily test different composition framings.

The CPU 9 relating to the first embodiment further includes a function that generates guide information that leads to a predetermined composition (for example, an ideal composition) on the basis of the identified model composition suggestion. The function of exhibition includes a function that exhibits this guide information. Therefore, even a user inexperienced in imaging may easily image principal objects with ideal compositions, attractive compositions and well-balanced compositions.

The CPU 9 relating to the first embodiment may guide a user to move or change framing, zooming or the like so as to make a composition corresponding to an identified model composition suggestion. The CPU 9 may further execute automatic framing, automatic trimming or the like and perform imaging so as to approach a composition corresponding to an identified model composition suggestion. When continuous shooting of a plurality of frames is implemented, the CPU 9 may use the continuously shot plurality of captured images as input images and identify respective model composition suggestions. Therefore, the CPU 9 may select an image with a good composition from among the plurality of continuously shot images on the basis of the identified model composition suggestions, and cause the captured image to be recorded. As a result, users may avoid monotonous compositions, and perform imaging with appropriate compositions. Moreover, a user capturing an image with mistaken compositions can be avoided.

### Second Embodiment

Next, a second embodiment of the present invention is described.

Herein, a hardware structure of an image processing device relating to the second embodiment of the present invention is basically the same as the hardware structure in FIG. 1 of the image processing device 100 relating to the first embodiment. The CPU 9 also includes functions the same as the above-described various functions of the CPU 9 of the first embodiment.

The image processing device 100 relating to the second embodiment also includes a function that exhibits a plurality of scenes to a user, on the basis of functions of “Picture Mode”, “BEST SHOT (registered trademark)” or the like.

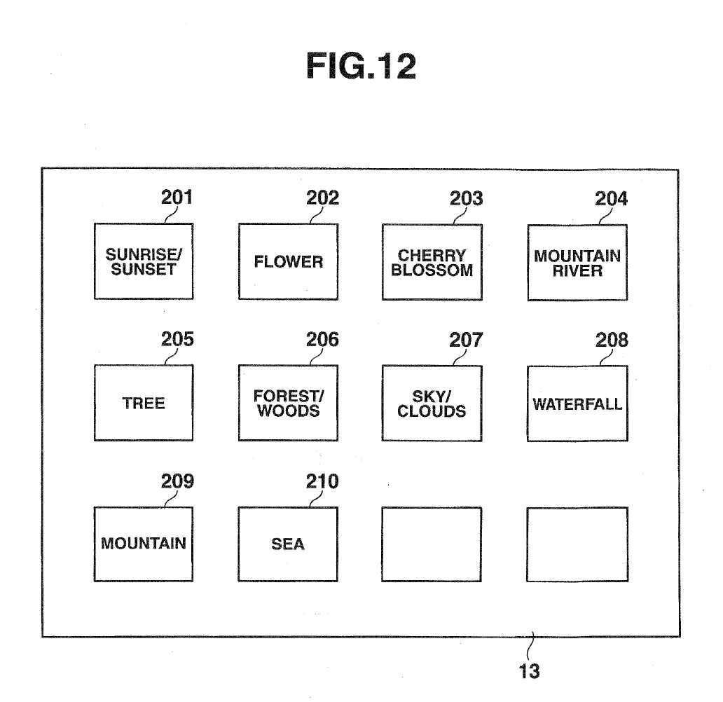

FIG. 12 illustrates a display example of the liquid crystal display 13, which is an example in which information sets capable of respectively specifying a plurality of scenes (hereinafter referred to as “scene information”) are displayed.

Scene information 201 shows a “sunrise/sunset” scene.

Scene information 202 shows a “flower” scene.

Scene information 203 shows a “cherry blossom” scene.

Scene information 204 shows a “mountain river” scene.

Scene information 205 shows a “tree” scene.

Scene information 206 shows a “forest/woods” scene.

Scene information 207 shows a “sky/clouds” scene.

Scene information 208 shows a “waterfall” scene.

Scene information 209 shows a “mountain” scene.

Scene information 210 shows a “sea” scene.

Herein, for simplicity of description, the scene information sets 201 to 210 are drawn in FIG. 12 such that titles of the scenes are shown, but the example of FIG. 12 is not limiting. For example, sample images of the scenes are just as acceptable.

A user can operate the operation section 14 and select desired scene information from the scene information sets 201 to 210. The image processing device 100 relating to the second embodiment includes the following function as a function for this selection. That is, the image processing device 100 includes a function that, in accordance with a scene corresponding to selected scene information, types of objects that may be included in the scene, a style of the scene and the like, identifies a model composition suggestion to be recommended for this scene from the plurality of model composition suggestions.

As a specific example, if the scene information 201 is selected, the image processing device 100 identifies the model composition C11, a “three part/four-part composition”, for a “sunrise/sunset scene”. Accordingly, the sun and the horizon may be disposed at positions in accordance with the three-part rule and captured.

As another example, if the scene information 202 is selected, the image processing device 100 identifies the model composition suggestion C7, a “contrasting/symmetrical composition”, for a “flower” scene. Accordingly, supporting elements that emphasize the flowers that are a principal element are obtained, and capturing an image with a “contrasting composition” between the principal element and the supporting elements is possible.

As another example, if the scene information 203 is selected, the image processing device 100 identifies the model composition suggestion C4, a “radial line composition”, for a “cherry blossom” scene. Accordingly, capturing an image of the trunk and branches of a tree in a “radial line composition” is possible.

As another example, if the scene information 204 is selected, the image processing device 100 identifies the model composition suggestion C12, a “perspective composition”, for a “mountain river” scene. Accordingly, capturing an image with the object that is the point of interest being disposed in a “perspective composition” emphasizing a sense of distance is possible.

As another example, if the scene information 205 is selected, the image processing device 100 identifies the model composition suggestion C7, a “contrasting/symmetrical composition”, for a “tree” scene. Accordingly, with background trees serving as supporting elements that emphasize an old tree or the like that is the principal element, capturing an image with a “contrasting composition” between the principal element and the supporting elements is possible. As a result, it is possible to bring out a sense of scale of the old tree or the like that is the principal object.

As another example, if the scene information 206 is selected, the image processing device 100 identifies the model composition suggestion C4, a “radial line composition”, for a “forest/woods” scene. Accordingly, capturing an image in a “radial line composition” with beams of light coming down from above and the trunks of trees as accent lines is possible.

As another example, if the scene information 207 is selected, the image processing device 100 identifies the model composition suggestion C4, a “radial line composition”, the model composition suggestion C3, an “inclined line composition/diagonal line composition”, or the like for a “sky/clouds” scene. Accordingly, capturing an image of lines of clouds in a “radial line composition” or “diagonal line composition” or the like is possible.

As another example, if the scene information 208 is selected, the image processing device 100 identifies a model composition suggestion that is capable of capturing an image for a “waterfall” scene with a flow of the waterfall that is caught with a low shutter speed as an “axis of the composition”.

As another example, if the scene information 209 is selected, the image processing device 100 identifies the model composition suggestion C3, an “inclined line composition/diagonal line composition”, for a “mountain” scene. Accordingly, it is possible to capture an image of ridgelines in an “inclined line composition” and produce a rhythmical sense in the captured image. In this case, it is ideal not to capture an image with too much sky.

As another example, if the scene information 210 is selected, the image processing device 100 identifies the model composition suggestion C1, a “horizontal line composition”, and the model composition suggestion C7, a “contrasting or symmetrical composition”, for a “sea” scene. Accordingly, capturing an image of the sea in a combination of a “horizontal line composition” and a “contrasting composition” is possible.

Thus, in the second embodiment, it is to be understood that the effects that can be realized by the first embodiment can be realized to the same extent, in addition to which the following effects can be realized.

This means that, in the second embodiment, when imaging programs of different scenes are selected and capturing an image is performed or the like, since the model composition suggestions corresponding to the scenes are identified, rather than just depending on arrangements and positional relationships of principal objects in the input images (through-images), an optimal model composition suggestion to enhance the scenes can be identified. As a result, anyone can capture an image with an ideal composition.

For example, sample images corresponding to the imaging programs of the different scenes, images captured by users as model composition suggestions, photographs of works by famous artists and the like may be additionally registered. In this case, the image processing device 100 may extract attention regions and the like from a registered image and, on the basis of the extraction results, automatically extract composition elements, arrangement patterns and the like. Hence, the image processing device 100 may additionally register the extracted composition elements, arrangement patterns and the like as new model compositions suggestion, arrangement pattern information sets or the like. In this case, when capturing an image with an imaging program specific to a particular scene, by selecting an additionally registered model composition suggestion, a user may perform imaging with a desired composition suggestion even more simply.

It should be noted that the present invention is not to be limited by the above embodiments, and that modifications, improvements and the like within a technical scope capable of achieving the object of the present invention are included in the present invention.

For example, in the embodiments described above, the image processing device to which the present invention is applied is described as being an example that is structured as a digital camera. However, the present invention is not to be particularly limited to digital cameras and may be applied to electronic equipment in general. As specific examples, the present invention is applicable to video cameras, portable navigation devices, portable videogame consoles and so forth.

Moreover, the first embodiment and the second embodiment may be combined.

The sequences of processing described above may be executed by hardware and may be executed by software.

If a sequence of processing is executed by software, a program constituting the software is installed on a computer or the like from a network or a recording medium or the like. A computer may be a computer that is incorporated in dedicated hardware. A computer may also be a computer that is capable of executing different kinds of functions by different kinds of programs being installed, e.g., a general purpose personal computer.

Although not illustrated, recording media containing this program, as well as being constituted by removable media that are distributed separately from the main body of the device for provision of the program to users, may be constituted by recording media that are provided to the users in a form that is pre-incorporated in the device main body. A removable medium is constituted by, for example, a magnetic disc (including floppy disks), an optical disc, a magneto-optical disc or the like. An optical disc is constituted by, for example, a CD-ROM (Compact Disc Read-Only Memory), a DVD (Digital Versatile Disc) or the like. A magnetic disc is constituted by, for example, an MD (Mini-Disk) or the like. A recording medium that is provided to users in a form that is pre-incorporated in the device main body is configured by, for example, the ROM 11 of FIG. 1 at which programs are recorded, an unillustrated hard disk or the like.

The steps that describe a program recorded at a recording medium in the present specification naturally encompass processing that is carried out chronologically in that sequence, and also processing that is not necessarily processed chronologically, but in which the steps are executed in parallel or separately.

What is claimed is:

1. An image processing device comprising:
a prediction section that predicts an attention region for an input image including a principal object, based on a plurality of feature quantities extracted from the input image; and
an identification section that identifies, using the attention region thus predicted by the prediction section, a model composition suggestion that resembles the input image in regard to a state of positioning of the principal object, from among a plurality of model composition suggestions.

2. An image processing device according to claim 1, wherein
the identification section identifies a composition suggestion that resembles the input image in regard to a state of positioning of the principal object using line components of an edge image corresponding to the input image, in addition to the attention region.

3. An image processing device according to claim 1, further comprising an exhibition section that exhibits the model composition suggestion identified by the identification section.

4. An image processing device according to claim 3, further comprising an evaluation section that performs evaluation on the model composition suggestion thus identified by the identification section,
wherein the exhibition section further exhibits an evaluation result from the evaluation section.

5. An image processing device according to claim 3, further comprising a generation section that generates guide information that leads to a predetermined composition, based on the model composition suggestion thus identified by the identification section,
wherein the exhibition section further exhibits the guide information generated by the generation section.

6. An image processing method comprising:
a prediction step of predicting an attention region for an input image including a principal object, based on a plurality of feature quantities extracted from the input image; and
an identification step of identifying, using the attention region predicted by the processing of the prediction step, a model composition suggestion that resembles the input image in regard to positioning of the principal object, from among a plurality of model composition suggestions.
